(19) United States
(12) Patent Application Publication
(10) Pub. No.: US 2002/0172218 A1
(43) Pub. Date: Nov. 21, 2002

(54) Communications device

(76) Inventor: Simon Harrison, High Wycombe (GB)

Correspondence Address: BEYER WEAVER & THOMAS LLP, P.O. BOX 778, BERKELEY, CA, 94704-0778, US

(21) Appl. No.: 10/049,609

(22) PCT Filed: Jun. 13, 2001
(86) PCT No.: PCT/GB01/02588

(30) Foreign Application Priority Data
Jun. 13, 2000 (GB) 0014431.1
Dec. 13, 2000 (GB) 0030408.9

(51) Int. Cl. H04L 12/42

(52) U.S. Cl. 370/449; 370/216

(57) ABSTRACT

The present invention provides a designated master communications device which is adapted to act as the master under all circumstances, together with a method of enforcing a master-slave relationship. This is achieved by having the designated master communications device detect the presence of any other communications device. When this is achieved, the communications device establishes a wireless connection with the other communications device such that the designated master communications device acts as the master. Any subsequent communication is then performed via this established wireless connection. This ensures that the designated master communications device operates as the master with any other device fitted thereto operating as a slave.

### FIELD OF THE INVENTION

The present invention relates to a designated master communications device for communicating with other communications devices via a wireless connection in accordance with a wireless communications protocol. The protocol is adapted to cause the communications device initiating in the connection to act as a master with the communications device accepting the connection acting as a slave. In the present invention the designated master communications device is adapted to act as the master at all times.

### BACKGROUND TO THE INVENTION

Currently, the majority of computer networks utilize some form of wiring for interconnecting the computers on the network. These systems suffer from the major drawbacks that wiring has to be installed within the building to enable the network to be fitted, and additionally, should a fault with the wiring develop, this can lead to the need for wiring to be replaced. In addition to this, the wiring can cause electromagnetic noise problems due to interference with other electrical equipment within the building, as well as only having a limited bandwidth. Furthermore, different networks require different wiring standards which further leads to the complexity of installing networks in buildings.

Wireless types of networks are now becoming more wide spread. Wireless communication can be broken down into one of three main categories, radio, cellular and local. Radio communications are used for mainly long distance work, and cellular communications are used for mobile phones and the like. At present, the cellular system can also be used to provide limited Internet access using WAP (Wireless Application Protocol) phones. Internet access is also possible via a cellular phone, a GSM modem and a PC/PDA.

In addition to this, the local communication standards are also provided for short-range radio communication. These systems have been used within the production of wireless networks.

One such short-range radio communication radio system is Bluetooth which can be used to provide customer premises wireless links for voice, data and multimedia applications.

A Bluetooth Radio Frequency (RF) system is a Fast Frequency Hopping Spread Spectrum (FFHSS) system in which packets are transmitted in regular time slots on frequencies defined by a pseudo random sequence. A Frequency Hopping system provides Bluetooth with resilience against interference. Interference may come from a variety of sources including microwave ovens and other communication systems operating in this unlicensed radio band which can be used freely around the world. The system uses 1 MHz frequency hopping steps to switch among 79 frequencies in the 2.4 GHz Industrial, Scientific and Medical (ISM) band at 1600 hops per second with each channel using a different hopping sequence.

The Bluetooth baseband architecture includes a Radio Frequency transceiver (RF), a Link Controller (LC) and a Link Manager (LM) implementing the Link Manager Protocol (LMP).

Bluetooth version 1.1 supports asymmetric data rates of up to 721 Kbits per second and 57.6 Kbits per second and symmetric data rates of up to 432.5 Kbits per second. Data transfers may be over synchronous connections, Bluetooth supports up to three pairs of symmetric synchronous voice channels of 64 Kbits per second each.

Bluetooth connections operate in something called a piconet in which several nodes accessing the same channel via a common hopping sequence are connected in a point to multi-point network. The central node of a piconet is called a master that has up to seven active slaves connected to it in a star topology. The bandwidth available within a single piconet is limited by the master, which schedules time to communicate with its various slaves. In addition to the active slaves, devices can be connected to the master in a low power state known as park mode, these parked slaves cannot be active on the channel but remain synchronised to the master and addressable. Having some devices connected in park mode allows more than seven slaves be attached to a master concurrently. The parked slaves access the channel by becoming active slaves, this is regulated by the master.

Multiple piconets with overlapping coverage may co-operate to form a scatternet in which some devices participate in more that one piconet on a time division multiplex basis. These and any other piconets are not time or frequency synchronised, each piconet maintains is own independent master clock and hopping sequence.

The Bluetooth protocol operates by having devices generating polling signals when they need to transfer data to another nearby Bluetooth enabled device. In this example, when a Bluetooth enabled device detects a polling signal, it generates a response causing a connection to be established between the two devices. In this example, the device generating the polling signal becomes the master, with the device accepting the polling signal being the slave. The operation of the Bluetooth protocol is configured so that the master Bluetooth device defines the hopping sequence used by the two devices.

In many circumstances, Bluetooth is used to allow one-to-one communication between two devices. Accordingly, in this circumstance, it does not matter which device is the slave and which is the master.

However, the present invention provides a system which uses a number of network nodes which can communicate wirelessly with end stations coupled to the network. The network nodes are interconnected to a network server, which can be used to provide additional services, such as Internet connection. The system uses at least a local short range radio connection for interconnecting the network nodes to the communications devices. This allows the user access to the network from anywhere within range of a network node. Accordingly, if network nodes are located throughout a building the user can have access to the communications network at any location within the building.

In order to provide a cost effective solution, the network nodes must be capable of communicating with a number of different devices simultaneously. In the case of Bluetooth this can only be achieved if the network node functions as a master of the piconet, with the communications devices operating as slaves. Thus, it is necessary for each of the Bluetooth network nodes to be configured as a master radio at all times. This ensures that even if a number of different slave devices are associated with any one given master, the slave devices all follow the hopping sequence of the master device.

As will be appreciated by a person skilled in the art, if the network node became a slave it would only be able to communicate with the communications device which is currently functioning as the master thereby preventing the network node communicating with other communications devices.

In order to overcome this problem, a roll change facility is provided within the Bluetooth specification. However, this is not currently implementable in all circumstances.

### SUMMARY OF THE INVENTION

In accordance with a first aspect of the present invention, we provide a designated master communications device for communicating with other communications devices via a wireless connection in accordance with a wireless communications protocol, the protocol being adapted to cause the communications device initiating the wireless connection to act as the master, the communications device accepting the connection acting as a slave, the designated master communications device being adapted to be the master and comprising:

a transceiver for transmitting and receiving signals; and,

a processor coupled to the transceiver, the processor being adapted to:

detect the presence of another communications device;

establish a wireless connection with the other communications device such that the designated master communications device acts as the master; and,

cause any subsequent communication to be performed via the established wireless connection.

In accordance with a second aspect of the present invention, we provide a method of enforcing a master and slave relationship between two communications devices communicating via a wireless connection in accordance with a wireless communications protocol, the protocol being adapted to cause the communications device initiating the wireless connection to act as the master, the method comprising:

designating one of the communications devices to be the master;

causing the designated master communications device to detect the presence of another communications device;

causing the designated master communications device to establish a wireless connection with the other communications device; and,

causing any subsequent communication to be performed via the established wireless connection.

Accordingly, the present invention provides a designated master communications device which is adapted to act as the master under all circumstances, together with a method of enforcing a master-slave relationship. This is achieved by having the designated master communications device detect the presence of any other communications device. When this is achieved, the communications device establishes a wireless connection with the other communications device such that the designated master communications device acts as the master. Any subsequent communication is then performed via this established wireless connection. Accordingly, this ensures that the designated master communications device operates as the master with any other device connected thereto operating as a slave.

The processor of the designated master communications device is usually adapted to detect the presence of the other communications device by detecting a polling signal generated by the other communications device, the polling signal being generated in accordance with the protocol to initiate a wireless connection. As mentioned in the introduction, when a communications device is to communicate, it generates a polling signal requesting that a wireless connection be initiated. Accordingly, as these polling signals are automatically generated when a connection is required, the designated master communications device can advantageously monitor for these polling signals. Alternatively however the designated master communications device can generate its own polling signals and await a response.

The processor is typically adapted to establish a wireless connection with the other communications device by generating a response to the polling signal thereby accepting the wireless connection from the other communications device such that the designated master communications device acts as a slave; breaking the wireless connection; and, establishing a new wireless connection such that the designated master communication device acts as the master. Thus, the designated master communications device initially accepts its roll as a slave and then causes the connection to be broken and a new connection established with the designated master communications device acting as the master.

In this case, if the designated master communications device is further connected to a number of slave communications devices, then the connection with the slave communications devices will be broken if the designated master communications device accepts a slave status. In order to overcome this problem the processor is preferably further adapted to establish the wireless connection with the other communications device by generating a standby signal causing the number of slave communications devices to enter a standby mode before accepting the wireless connection from the other communications device; and, generating a wake-up signal causing the number of slave communications devices to be revived from the standby mode once the wireless connection has been established. Thus the designated master communications device temporarily places the other communications devices in a standby mode so that they do not need to communicate with the master. The designated master communications device can then take on a temporary slave status whilst the other devices are in standby mode. The designated master communications device can then reawaken the slave communications device once it has regained its master status.

As an alternative however the designated master communications device could be adapted to implement two hopping sequences using a scatternet feature of the Bluetooth protocol. In this case, the designated master communications device would maintain a first master hopping sequence for connection with the slave communications devices whilst implementing a new hopping sequence for communication as a slave with the other communications device. Accordingly, the wireless connection with the slave communications devices form a first piconet, and the wireless connection with the other communications device forms a second piconet. Once communication is established, the master slave relationship can be altered so that the designated master communications device is the master of all other communications devices. The two hopping sequences can then be recombined to form a single hopping sequence.

As an alternative to accepting a wireless connection from the other communications device, the processor can be adapted to establish a wireless connection with the other communications device by failing to generate a response to the polling signal, thereby rejecting the wireless connection from the other communications device; and, establishing new wireless connections such that the designated master communications device acts as the master. This therefore obviates the need for causing other slave devices to go to sleep, or the like.

Preferably, the processor is adapted to establish a new wireless connection by generating a polling signal, the polling signal being transmitted to the other communications device by the transceiver. However, this will typically depend on the wireless communications protocol being used.

The communications device may be a call handling device for connecting the other communications devices to communications networks. The call handling device typically includes an output for connecting the call handling device to the communications network. As will be apparent from the description below, this call handling device is typically formed from a Access Server (Wireless Internet Server) coupled to at least one or more Access Points (LAN access devices), although any suitable system can be used. As will be apparent from this, the designated master communications device could therefore be a network node that provides wireless connectivity to external devices.

Preferably, the wireless communications protocol is the Bluetooth protocol. However, the invention is equally applicable to other wireless communication protocols.

Typically, the other communications devices include any one of telephones, computing devices, printers, PDAs, headsets or the like.

### BRIEF DESCRIPTION OF THE DRAWINGS

Examples of the present invention will now be described in detail with reference to the accompanying drawings, in which:

FIG. 1 is a schematic representation of a mater-slave controlled radio communication system according to the present invention;

FIG. 2 is a schematic representation of a network according to the present invention;

FIG. 3 is a schematic diagram of the Access Server of FIG. 2;

FIG. 4 is a schematic diagram of the Access Point of FIG. 2; and,

FIG. 5 is an example of the functionality of the Access Server 1 and the Access Points 2.

### DETAILED DESCRIPTION

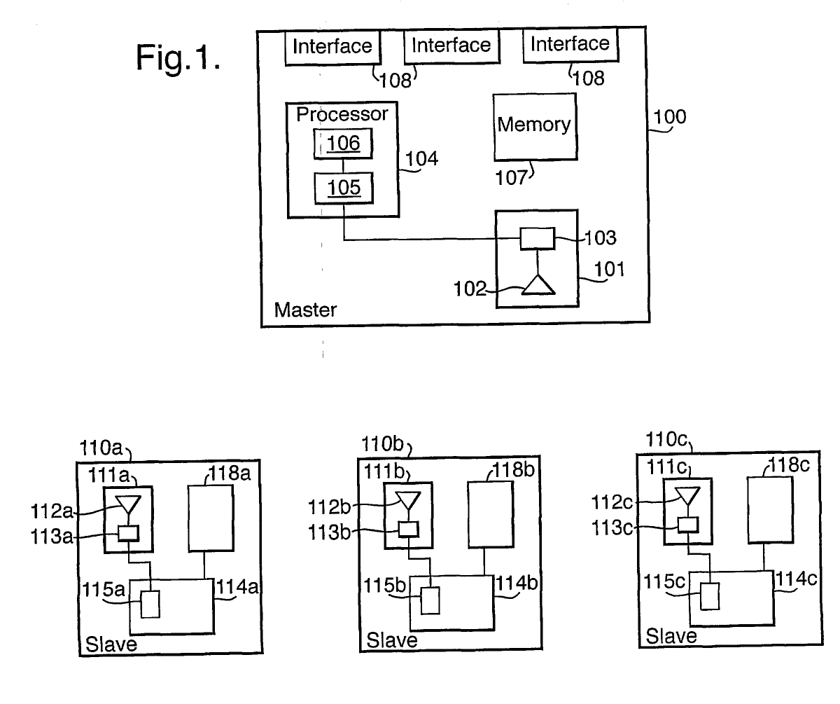

FIG. 1 shows a master-slave control system according to the present invention. The system includes a master unit 100 adapted for radio communications with a number of slave units 110a,110b,110c.

The master unit includes a Bluetooth radio 101 including a radio 102 and a first Bluetooth stack 103. The radio 101 is coupled to a processor 104 which includes a second Bluetooth stack 105 and a connection manager 106 as shown. A memory 107 is also generally provided within the master unit 100. The master unit may also include one or more interfaces 108 for connecting to other communications systems, such as communications networks, local area networks, wide area networks, the Internet, or the like.

As shown each of the slave units 110 includes a Bluetooth radio 111 including a radio 112 and a first Bluetooth stack 113. Coupled to the Bluetooth radio 101 is a processor 104 which in turn is coupled to an input/output device 108. Again, the processor 104 includes a second Bluetooth stack 115.

In use, each of the slave units 110a,110b,110c is capable of communicating with the master unit 100 using the Bluetooth communication protocol.

In such operation, data received at the Bluetooth radio 101 is received by the radio 102 and transferred to the first Bluetooth stack 103. The Bluetooth stack is used to place the data into the Bluetooth HCI (Host Controller Interface) format suitable for transmission over a connection, such as an RS232 connection, to the processor 104. Upon receipt by the processor 104 the data is transferred to the second Bluetooth stack 105 which operates to translate the data from the HCI format into the basic data being transferred. As will be appreciated, the first and second Bluetooth stacks 103,105 therefore function as a single Bluetooth stack split at the HCI layer so that HCI commands can be sent between the first and second stacks via the connection.

A similar operation occurs for the first and second Bluetooth stacks 113,115 in the slave units 110a,110b,110c. Accordingly, the first and second Bluetooth stacks 103,105 and 113,115 will hereinafter simply be referred to as a Bluetooth stack 103,105 and 113,115.

The connection manager 106 receives control information from the Bluetooth stack 103,105 and then operates to control the transfer of data accordingly. Thus, the data may be transferred out of the master unit 100 via one of the interfaces 108. Alternatively, the data may be processed by the master unit or transferred back to the radio 101 for subsequent transmission to one of the slave units 110a,110b,110c.

Similarly, each of the slave units is capable of receiving data via the radio 111. In this case, the data is transferred via the Bluetooth stack 113,115 to the processor 114. The data can then be processed by the processor 114 or transferred to the input/output device 118 for presentation to a user of the slave unit.

In use, when one of the slave units 110a is initially brought into range of the master unit 100 it is necessary for a connection to be established between the two devices. In order to do this, the Bluetooth communication protocol causes one of the devices to generate a polling signal. In-general, the polling-signal will be generated by the device which wants to initiate a connection.

Thus, if the master unit 100 is attempting to connect to a slave unit, the Bluetooth stack 103,105 will be used to generate a polling signal which is then broadcast via the radio 102. Upon receipt of the polling signal, the slave unit 110a will generate a response which operates to synchronize the packet hopping sequences of the master unit 100 and the slave unit 110a. When this has been completed, a connection is in place between the two devices allowing communication to be achieved. In this case, the master unit 100 acts as the master and is therefore in control of the hopping sequence.

However, problems arise when the slave unit 110a attempts to transfer data to the master unit. In this case, the Bluetooth stack 113,115 of the slave unit 110a will generate the polling signal which is transferred via the radio 112 to the master unit 100. The master unit will detect the polling signal and under normal circumstances would generate a response. The generation of this response would cause a connection to be initiated between the slave unit 110a and the master unit 100 in which the master unit 100 is acting as a slave. In this circumstance, the hopping sequence of the master unit is synchronized with that of the slave unit 110a. This would override any currently existing hopping sequence.

Thus, if the slave units 110b and 110c were currently in communication with the master unit 100, the master units hopping sequence would be changed causing the currently existing connections to be broken.

In order to overcome this, the present invention uses a roll change feature to ensure that the master unit 100 remains as the master.

Accordingly, all communication between the slave units 110b,110c and the master unit 100 would be lost.

In order to overcome this, the master unit is adapted to maintain its status as a master under all circumstances.

Accordingly, if the slave unit 110a generates a polling signal requesting a connection with the master unit 100, then any one of the following four techniques can be implemented.

Technique 1

1. The polling signal is received by the radio 101 and transferred to the Bluetooth stack 103,105.

2. The connection manager 106 uses control signals received from the Bluetooth stack 103,105 to determine that a connection is required with the slave unit 110a.

3. The connection manager 106 determines that this connection should be implemented with the master unit 100 remaining as the master.

4. Under normal circumstances, the Bluetooth stack 103,105 would generate a response signal causing a connection to be implemented. In this technique, the connection manager 106 overrides the Bluetooth stack to prevent the response signal being generated. No connection is made between the master unit 100 and the slave unit 110a.

5. The connection manager 106 causes the Bluetooth stack 103,105 and hence the radio 101 to generate a polling signal in accordance with any currently existing hopping sequences.

6. The polling signal is detected by the slave unit 101a.

7. The Bluetooth stack 113,115 generates a response which is transferred back to the master unit 100 causing a connection to be established in accordance with the master unit hopping sequence.

Accordingly, in this technique the master unit refuses to accept a connection from the slave unit 110 and instead forces the slave unit 110 to accept its own connection request. This forces the slave unit 110 to follow the hopping sequence of the master unit 100 thereby maintaining the master unit's status as a master.

Technique 2

1. The polling signal is received by the radio 101 and transferred to the Bluetooth stack 103,105.

2. The connection manager 106 uses control signals received from the Bluetooth stack 103,105 to determine that a connection is required with the slave unit 110a.

3. The connection manager 106 determines that this connection should be implemented with the master unit 100 remaining as the master.

4. The Bluetooth stack 103,105 generates a response to the polling signal which is transferred by the radio 101 to the slave unit 101a.

5. This causes a connection to be established between the slave unit 110a and the master unit 100. In this case, the hopping sequence of the master unit follows that of the slave unit 110a and accordingly, the master unit is acting as a slave.

6. This is detected by the connection manager 106 which then causes the connection to be broken.

7. The connection manager 106 then causes the Bluetooth stack 103,105 to generate a new polling signal which is transferred via the radio 101 to the slave unit 110a.

8. The Bluetooth stack 113,115 then generates a response causing the slave unit 110a to be connected to the master unit 100 in accordance with the master unit's hopping sequence. Accordingly, the slave unit is now acting as a slave.

Accordingly, in this technique the master unit initially accepts the connection from the slave unit 110. The master unit 100 then breaks the connection and forces the slave unit 110 to accept its own connection request. This forces the slave unit 110 to follow the hopping sequence of the master unit 100 thereby maintaining the master units status as a master.

As an additional point, when the master unit initially accepts the connection with the slave unit 110a, this means that the master unit 100 must follow the hopping sequence of the slave unit 100a. This will disrupt the master units hopping sequence. Accordingly, if one of the other slave units 110b,110c was connected to the master unit 100, this would cause the connection to be broken.

In order to overcome this, an additional step can be performed of having the connection manager 106 cause the Bluetooth stack 103,105 to generate additional polling signals. These signals cause new connections to be initiated with the slave units 110b and 110c thereby reestablishing their master slave relationship.

Technique 3

1. The polling signal is received by the radio 101 and transferred to the Bluetooth stack 103,105.

2. The connection manager 106 uses control signals received from the Bluetooth stack 103,105 to determine that a connection is required with the slave unit 110a.

3. The connection manager 106 determines that this connection should be implemented with the master unit 100 remaining as the master.

4. The connection manager 106 generates a standby signal which is transferred via the Bluetooth stack 103,105 and the radio 101 to each of the slave units 110b,110c.

5. The slave units 110b and 110c enter a standby state in which they do not communicate with the master unit 100 until a wake up signal is received.

6. The connection manager 106 causes the Bluetooth stack 103,105 to generate a response to the polling signal from the slave unit 110a.

7. The master unit 100 is therefore connected to the slave unit 110a as a slave such that the master unit's hopping sequence follows that of the slave unit 110a.

8. The connection manager 106 causes the connection to be broken.

9. The connection manager 106 then causes the Bluetooth stack 103,105 to generate a new polling signal which is transferred via the radio 101 to the slave unit 110a.

10. The Bluetooth stack 113,115 then generates a response causing the slave unit 110a to be connected to the master unit 100 in accordance with the master units hopping sequence. Accordingly, the slave unit is now acting as a slave.

11. The connection manager 106 causes a wake up signal to be transferred via the radio 101 to the slave units 110b,110c causing them to wake up.

Accordingly, in this technique the master unit temporarily places any currently existing slave units in a standby mode, and then accepts the connection with the new slave unit 110a. The connection is then broken and reestablished by the master unit 100 such that the slave unit 110a acts as a slave. The original slave units 110b,110c are then woken up.

It will be appreciated that under some circumstances, the connection between the master unit 100 and the slave units 110b,110c may be broken whilst the slave units are in standby mode. This can be overcome however by simply forming a new connection with the slave units 110b,110c once the connection with the slave unit 110a has been established in step 10.

Technique 4

1. The master unit 100, which is currently the master of a first piconet formed with slave units 110b,110c receives a polling signal from the slave unit 110a. The polling signal is received by the radio 101 and transferred to the Bluetooth stack 103,105.

2. The connection manager 106 uses control signals received from the Bluetooth stack 103,105 to determine that a connection is required with the slave unit 110a.

3. The connection manager 106 determines that this connection should be implemented with the master unit 100 remaining as the master.

4. The connection manager 106 causes the Bluetooth stack 103,105 to generate a response to the polling signal from the slave unit 110a. Simultaneously, the Bluetooth stack 103,105 implements the “Scatternet” Bluetooth feature to allow two hopping sequences to be implemented concurrently, which in turn allows the master unit to connect to two piconets simultaneously.

5. The master unit 100 therefore remains connected to the slave units 110b,110c to form a first piconet using the first original hopping sequence, as well as forming a second piconet with the slave unit 110a. The master unit forms the slave in the second piconet and therefore uses a second hopping sequence which follows that of the slave unit 110a.

6.The connection manager 106 then causes the Bluetooth stack 103,105 to break the connection with the slave unit 110a, thereby breaking up the second piconet. The connection manager 106 generates a new polling signal which is transferred via the radio 101 to the slave unit 110a to cause the slave unit to accept a connection on the basis of the master unit's first original hopping sequence.

7. The Bluetooth stack 113,115 then generates a response causing the slave unit 110a to be connected to the master unit 100 in accordance with the master unit's first original hopping sequence. Accordingly, the slave unit 110a is connected to the master unit 100 so as to form part of the first piconet.

Accordingly, in this technique the master unit accepts a connection from the slave unit 110a by using a scatternet procedure to form a second piconet. This connection can then be broken before the master unit initiates a further connection in which the slave unit is following the original hopping sequence of the master unit 100. During this time, the scatternet feature allows other slave units 110b,110c to remain connected to the master unit 100 forming the first piconet.

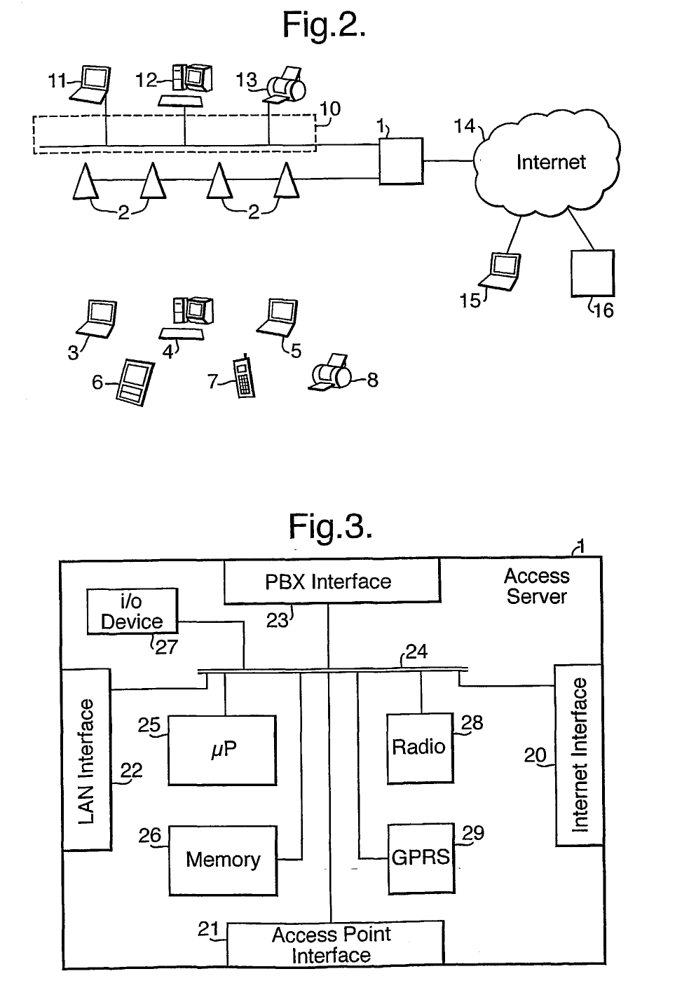

The above explains the general techniques of the present invention. An example of circumstances in which the general techniques are used will now be described with reference to FIGS. 2 to 4.

FIG. 2 shows a basic network arrangement which includes an Access Server 1 which is coupled to a number of local area network Access Point 2. The Access Points 2 are designed to communicate with a number of wireless communications devices 3,4,5,6,7,8 using a wireless communications protocol, which in this example is the Bluetooth protocol.

The wireless communication devices 3,4,5,6,7,8 can include devices such as a personal computer, laptop or the like which is fitted with a Bluetooth adapter, a specialised Bluetooth laptop, a Bluetooth enabled phone or mobile phone, a WAP Internet phone, a Bluetooth enabled printer, a Bluetooth enabled personal data assistant (PDA) or a Bluetooth headset. In this example, each of these devices will be able to communicate with the Access Points thereby allowing the devices to obtain data from, or send data to the Access Server.

In fact, the Access Server & Access Point can communicate with any Bluetooth enabled device. These include not only PCs, PDAs, and laptops but any of the following that have a Bluetooth port; a truck, a refrigerator, a baggage trolley, a keyboard etc.

The Access Server 1 is also optionally connected to a local area network 10 having a number of end stations 11,12,13. In this example, this allows the Access Server to be integrated with currently existing local area networks within a building.

The Access Server 1 can also be connected to a remote communications network 14, which in this example is the Internet. This allows the communications devices coupled to the Access Server to communicate with remote users 15 or Access Servers of other remote sites 16.

Accordingly, the Access Points 2 allow the wireless communications devices 3,4,5,6,7,8 to communicate with the LAN 10 and the Internet 14 via the Access Server 1. The Access Server will typically operate as a network server and can therefore typically store information to be retrieved by the communications devices, including information downloaded from the Internet.

The Access Server is shown in more detail in FIG. 3.

The Access Server may include an Internet interface 20, a Access Point interface 21, a LAN interface 22 and a PBX interface 23, all of which are interconnected via a bus 24. A microprocessor 25 and a memory 26 which are provided for processing and storing the operating software, are also coupled to the bus 24. An input/output device 27 is also provided.

The processor 25 is typically an x86 type processor operating a Linux type operating system such as Red Hat Linux. This is particularly advantageous as the Linux system is widely used as the operating system for a number of different software applications. Accordingly, the system can implement a wide variety of standard operating software for network servers and the like, as well as allowing third parties the opportunity to modify existing software and develop their own software. However, any suitable form of processing system may be used.

In addition to these features, it is also possible to include a number of Bluetooth radios 28, and a GPRS transceiver 29, both of which are coupled to the BUS 24.

A range of radios are supported, including standard and enhanced range devices.

Similarly, the Bluetooth design of the Access Server and the Access Point offers capabilities beyond the basic Bluetooth specification. These include advanced control of Bluetooth device state to improve throughput, and control of broadcast and multicast traffic streams to/from Bluetooth devices.

In this example, four different interfaces 20,21,22,23 are shown. However, it is not essential for the Access Server 1 to include all of these interfaces, depending on the particular configuration which is to be used, as will be explained in more detail below.

Thus, in order to enable Bluetooth communication between the wireless communication devices and the Access Server, only the Access Point interface 21, with appropriately connected Access Points 2, is required. In this case the Internet interface 20, the LAN interface 22 and the PBX interface 23 are not necessarily required. Alternatively, the Access Point interface need not be used if the Bluetooth radio in the Access Server is used instead. However, this will become clearer when various network configurations used by the Access Server are described in more detail below.

The Internet interface 20 may be provided by providing an ISDN connection to an Internet service provider. However, the system can be reconfigured to use Ethernet, DSL or a POTS modem for Internet connectivity.

The Access Point interface 21 is effectively an Ethernet interface which is adapted to operate with the Access Points, as will be explained in more detail below.

The LAN interface 22 is normally configured to be an Ethernet interface. However, this can be adapted to provide token ring or other forms of communication as required. Accordingly the LAN 10 can comprise an Ethernet, Token Ring or other similar network.

In order to be able to handle different communications protocols, each of the interfaces 20,21,22 will include a processor and a memory. The processor operates software stored in the memory which is appropriate for handling the required communications protocol. Thus in the case of the LAN interface 21, the default protocol is Ethernet. However, if alternative protocols such as Token Ring or ATM are used, then the software is adapted to translate the format of the data as it is transferred through the respective interface.

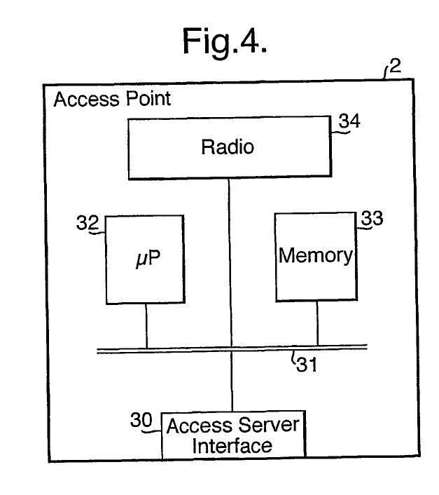

An Access Point according to the present invention is shown in FIG. 4. The Access Point includes a Access Server interface 30, for connecting the Access Point to the Access Server. The Access Server interface 30 is connected via a BUS 31 to a processor 32 and a memory 33. The BUS is also coupled to a number of Bluetooth radios 34 (only one shown) providing enhanced capabilities such as improved bandwidth and call density.

The processor 32 is typically a processor system that can include one or more processors, of the same or different types within the system. For example, the processor system could include, but is not be limited to, a RISC (Reduced Instruction Set Computer) processor and a DSP (Digital Signal Processor) processor.

In use, the Access Points are usually connected to the Access Point interface using a daisy chain Ethernet connection. This is particularly advantageous as it allows a large number of Access Points 2 to be connected in series via a single wire to the Access Point interface 21. In this case, power can be supplied to the Access Points 2 either via the connection from the Access Server 1, or via separate power supplies (not shown) connected to each of the Access Points 2 as required.

As an alternative however, the Access Points 2 can be connected to the Access Server 1 via an Ethernet hub. This would allow a larger number of Access Points 2 to be connected to each Access Server 1.

In use, each Access Point 2 is able to communicate with a number of communications devices 3,4,5,6,7,8 which are in range of the respective radio 34. Any data received at the radio is transferred to the memory 33 for temporary storage. The processor 32 will determine from the data the intended destination. If this is another Bluetooth device within range of the Access Point, the data will be transferred via the radio 34 to the appropriate communications device 3,4,5,6,7,8. Other Access Servere the data will be transferred via the BUS 31 to the Access Server interface 30 and on to the Access Server 1.

Upon receipt of the data by the Access Server 1, the Access Point interface 21 will temporarily store the data in the memory whilst the processor determines the intended destination of the data. The processor may also operate to translate the format of the data, if this is necessary. The data is then routed by the Access Server to the intended destination on either the LAN 2, the Internet 14 or alternatively, to a PBX network, as will be described in more detail below.

The traffic from Bluetooth devices (arriving through a Access Point or the Access Server) can be sent to the LAN through a number of different mechanisms; one is routing, another uses a technique called Proxy ARP to reduce the configuration needed. These mechanisms are bi-directional and also connect traffic from the LAN to Bluetooth devices.

Similarly, data can be transferred from the Access Server, via the Access Point interface 21 to a Access Point 2. In this case, the Access Point 2 receives the data and transfers it into the memory 33. The processor 32 then uses the data to determine the intended destination communication device before routing the data appropriately.

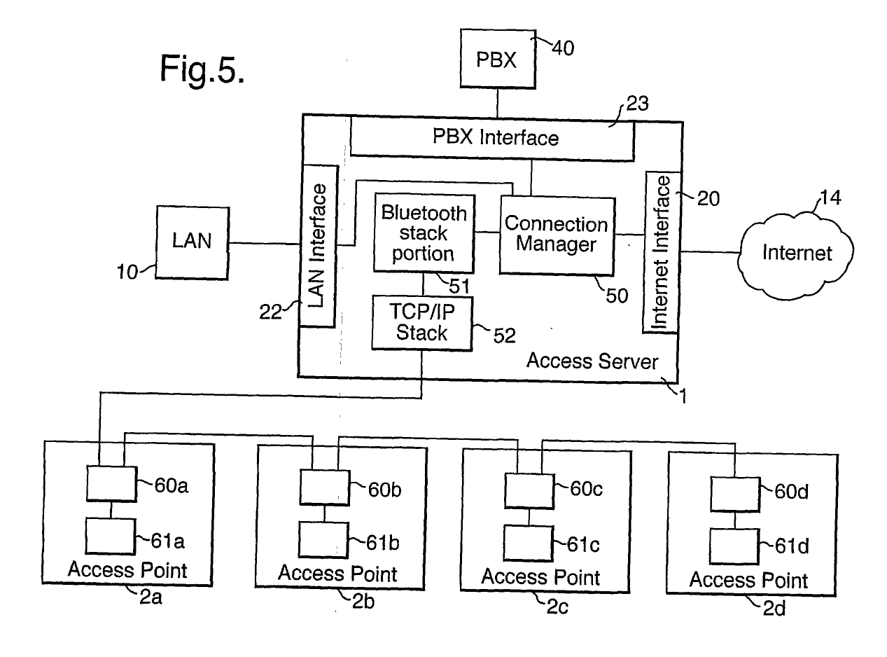

The functionality of the operation of the Access Server 1 and the Access Point 2, in accordance with the present invention will now be described with reference to FIG. 5.

As shown in this example, the Access Server 1 includes a connection manager 50 which is coupled to the Internet interface 20, the LAN Interface 22 and the PBX Interface 23, as well as being coupled to a Bluetooth stack 51 and a TCP/IP stack 52, as shown. The connection manager is a software implemented device which is typically implemented using the processor 25.

The Bluetooth stack 51 and TCP/IP stack 52 are also software implemented and again this may be achieved by the processor 25. More typically however, the Bluetooth stack and the TCP/IP stack are implemented by the processor in the Access Point interface 21. However, this is not important for the operation of the present invention.

In use, the connection manager 50 operates to provide control signals for controlling the operation of the Internet interface 20, the Access Point interface 21, the LAN interface 22 and the PBX interface 23. Similarly, the connection manager 50 controls the transfer of data through the Access Server 1.

As also shown in FIG. 5, the Access Points 2a-2d include respective TCP/IP stacks 60a-60d and Bluetooth stacks 61a, 61b. Again, the TCP/IP stack and the Bluetooth stacks 60,61 may be implemented within the Access Server interface 30, or within the processor 32.

In use, data received at the Bluetooth radio 3, is typically temporarily stored in the memory 33 before being transferred to the processor 32. At this stage, the Bluetooth stack 61 is used to place the data into the Bluetooth HCI (Host Controller Interface) format suitable for transmission over an RS232 connection in accordance with the Bluetooth specification.

In the present example, the data is transferred to the TCP/IP stack 60 which converts the data into a format suitable for transmission over the Ethernet connection to the Access Server 1.

Upon receipt of the data at the Access Server 1 the data is transferred to the TCP/IP stack 52 which converts the data back into the Bluetooth HCI format for transfer over the connection to the Bluetooth stack 51. The Bluetooth stack 51 operates to translate the data from HCI format into the basic payload data which can then be transferred onto one of the Internet interface 20, the LAN interface 22 or the PBX interface 23.

The routing of the data is achieved in accordance with routing information which is interpreted by the connection manager 50. The connection manager 50 also determines various information about the Bluetooth connection from the Bluetooth stack 51. This typically includes information concerning the signal strength between the Access Points 2 and the communications device 3,4,5,6,7,8 currently connected to the Access Point. The determination of the signal strength can be either a direct determination of the strength of signal that is required to communicate with the communications device, or alternatively or additionally, this may be an indication of the number of errors received per unit time.

Accordingly, as will be appreciated from the above, the Access Server 1 and one of the Access Points 2 will therefore function equivalently to the master unit 1 of FIG. 1. Accordingly, this allows the Access Server 1 and the Access Point 2 to implement the roll change feature of the present invention.

This ensures that the Access Point 2 can always form the master as far as communication between the Access Point 2 and the communications devices 3,4,5,6,7,8 is concerned. This in turn allows each Access Point 2 to be coupled to one or more communications devices 3,4,5,6,7,8, allowing the configuration shown in FIG. 2 to function as a network, with wireless connections to the communications devices 3,4,5,6,7,8. Accordingly, in this example, the Access Points 2 function as network nodes, with the Access Server 1 forming the network server to control the operation of the network.

As will be appreciated by a person skilled in the art, this allows a number of different network configurations to be implemented.

1. A designated master communications device for communicating with other communications devices via a wireless connection in accordance with a wireless communications protocol, the protocol being adapted to cause the communications device initiating the wireless connection to act as the master, the communications device accepting the connection acting as a slave, the designated master communications device being adapted to be the master and comprising:
a transceiver for transmitting and receiving signals; and,
a processor coupled to the transceiver, the processor being adapted to:
detect the presence of another communications device;
establish a wireless connection with the other communications device such that the designated master communications device acts as the master; and,
cause any subsequent communication to be performed via the established wireless connection.

2. A designated master communications device according to claim 1, wherein the processor is adapted to detect the presence of the other communications device by detecting a polling signal generated by the other communications device, the polling signal being generated in accordance with the protocol to initiate a wireless connection.

3. A designated master communications device according to claim 2, wherein the processor is adapted to establish a wireless connection with the other communications device by:
generating a response to the polling signal thereby accepting the wireless connection from the other communications device such that the designated master communications device acts as a slave;
breaking the wireless connection; and,
establishing a new wireless connection such that the designated master communications device acts as the master.

4. A designated master communications device according to claim 3, wherein the designated master communications device is further connected to a number of slave communications devices via a number of wireless connections, and wherein the processor is further adapted to establish the wireless connection with the other communications device using a scatternet such that the wireless connection with the slave communications devices form a first piconet, and the wireless connection with the other communications device forms a second piconet.

5. A designated master communications device according to claim 4, wherein the processor is further adapted to establish the new wireless connection with the other communications device such that the new wireless connection forms part of the first piconet.

6. A designated master communications device according to claim 3, wherein the designated master communications device is further connected to a number of slave communications devices via a number of wireless connections, and wherein the processor is further adapted to establish the wireless connection with the other communications device by:
generating a standby signal causing the number of slave communications devices to enter a standby mode before accepting the wireless connection from-the other communications device; and,
generating a wake-up signal causing the number of slave communications devices to be revived from the standby mode once the new wireless connection has been established.

7. A designated master communications device according to claim 2, wherein the processor is adapted to establish a wireless connection with the other communications device by:
failing to generate a response to the polling signal, thereby rejecting the wireless connection from the other communications device; and,
establishing a new wireless connection such that the designated master communications device acts as the master.

8. A designated master communications device according to any of the preceding claims, wherein the processor is adapted to establish a new wireless connection by generating a polling signal, the polling signal being transmitted to the other communications device via the transceiver.

9. A designated master communications device according to any of the preceding claims, wherein the designated master communications device is a call handling device for connecting the other communications devices to a communications network, the call handling device including an output for connecting the call handling device to the communications network.

10. A designated master communications device according to any of the preceding claims, wherein the wireless communications protocol is the bluetooth protocol.

11. A communications device according to any of the preceding claims, wherein the other communications device includes any one of telephones, computing devices, printers, PDAs, computer peripherals, and headsets.

12. A method of enforcing a master and slave relationship between two communications devices communicating via a wireless connection in accordance with a wireless communications protocol, the protocol being adapted to cause the communications device initiating the wireless connection to act as the master, the method comprising:
designating one of the communications devices to be the master;
causing the designated master communications device to detect the presence of another communications device;
causing the designated master communications device to establish a wireless connection with the other communications device; and,
causing any subsequent communication to be performed via the established wireless connection.

13. A method according to claim 12, wherein the method of detecting the presence of the other communications device comprises detecting a polling signal generated by the other communications device, the polling signal being generated in accordance with the protocol to initiate a wireless connection.

14. A method according to claim 13, wherein step (c) comprises the steps of:
causing the designated master communications device to generate a response to the polling signal thereby accepting the wireless connection from the other communications device such that the designated master communications device acts as a slave communications device;
causing the designated master communications device to break the wireless connection; and,
causing the designated master communications device to establish a new wireless connection such that the designated master communications device acts as the master.

15. A method according to claim 14, wherein the designated master communications device is further connected to a number of slave communications devices, wherein step (c) further comprises:
causing the designated master communications device to place the number of slave communications devices in a standby mode before accepting the wireless connection from the other communications device; and,
reviving the number of slave communications devices from the standby mode once the new wireless connection has been established.

16. A method according to claim 13, wherein step (c) comprises the steps of:
causing the designated master communications device to fail to generate a response to the polling signal thereby rejecting the wireless connection from the other communications device; and,
causing the designated master communications device to establish a new wireless connection such that the designated master communications device acts as the master.

17. A method according to any of claims 12 to 18, wherein the communications protocol is the Bluetooth protocol.
